(19) United States
(12) Patent Application Publication
(10) Pub. No.: US 2006/0009984 A1
(43) Pub. Date: Jan. 12, 2006

(54) Computer apparatus and control method thereof

(75) Inventor: Dong-hyun Lim, Suwon-Si (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., LTD, Suwon-si (KR)

(21) Appl. No.: 11/132,318

(22) Filed: May 19, 2005

(30) Foreign Application Priority Data
Jun. 25, 2004 (KR) 2004-48357

(51) Int. Cl. G10L 21/00

(52) U.S. Cl. 704/500

(57) ABSTRACT

A computer apparatus and a control method thereof. The computer apparatus includes: a computer main body including a main output device outputting an audio signal, a controller, and a connecting part; a first auxiliary output device to output an audio signal; and a second auxiliary output device to output the audio signal. The first auxiliary output device and the second auxiliary output device are selectively connectable to the connecting part. The connecting part detects whether either the first auxiliary output device or the second auxiliary output device is connected thereto. The controller controls the output of the audio signal so that the audio signal is concurrently output through the main output device and the first auxiliary device when the connecting part detects that the first auxiliary output device is connected to the connecting part.

### CROSS-REFERENCE TO RELATED APPLICATION

This application claims the benefit of Korean Patent Application No. 2004-0048357, filed Jun. 25, 2004, in the Korean Intellectual Property Office, the disclosure of which is incorporated herein by reference.

### BACKGROUND OF THE INVENTION

1. Field of the Invention

The present invention relates to a computer apparatus and control method thereof, and more particularly, to a computer apparatus and control method thereof improving sound by maintaining output of a main speaker when an auxiliary speaker is connected thereto.

2. Description of Related Art

Generally, an audio system of a computer apparatus includes an audio compressor/decompressor (codec), an audio amplifier, and a main speaker. Also, a user may selectively connect a pair of headphones to a headphone jack and listen to an audio signal through the headphones.

FIG. 1 illustrates an audio amplifier and a peripheral circuit of a conventional computer apparatus.

As shown in FIG. 1, an audio amplifier 300 of a conventional computer apparatus includes a headphone connection detecting pin (hereinbelow, referring to “HP-IN pin”). When the HP-IN pin is in a low state, the audio amplifier 300 is operated in a speaker mode in which an audio signal is outputted through a main speaker. When the HP-IN pin is in a high state, the audio amplifier 300 is operated in a headphone mode in which output of the main speaker is cut off and the audio signal is outputted through a headphone.

When a headphone plug 318 (of the 3 band (2 ring) type having Audio R 318b, Audio L 318a, Ground 318c portions) is connected to a headphone jack 316 (of a 2 position type), a control pin 306 in the headphone jack 316 is opened, and the HP-IN pin will be in a pull-up state by a resistor R1 302 and a resistor R4 304. When the headphone plug 318 is not connected to the headphone jack 316, the control pin 306 in the headphone jack 316 is connected to an end of a resistor R2 308. Herein, the value of the resistor R1 302 is larger than the value of the resistor R2 308, so that the HP-IN pin is in a low state. Accordingly, when the headphone is connected thereinto, a computer apparatus is operated in the headphone mode. Also, when the headphone is not connected thereto, the computer apparatus is operated in the speaker mode.

Meanwhile, an audio plug of an auxiliary speaker such as a subwoofer may be connected to the headphone jack 316 so as to improve the sound quality of the computer apparatus.

Because the audio plug of the auxiliary speaker includes a 3 band- (2 ring-) typed audio plug having the same type as the headphone plug 318, the HP-IN pin of the audio amplifier 300 receives a high signal so that the audio amplifier 300 drives in the headphone mode and the main speaker is mute. Accordingly, there is a limit in improving the sound.

### BRIEF SUMMARY

Accordingly, it is an aspect of the present invention to provide a computer apparatus and control method thereof improving sound by maintaining output of a main speaker when an auxiliary speaker is connected thereto.

According to an aspect of the present invention, there is provided a computer apparatus including: a computer main body including a main output device outputting an audio signal, a controller, and a connecting part; a first auxiliary output device to output an audio signal; and a second auxiliary output device to output the audio signal. The first auxiliary output device and the second auxiliary output device are selectively connectable to the connecting part. The connecting part detects whether either the first auxiliary output device or the second auxiliary output device is connected thereto. The controller controls the output of the audio signal so that the audio signal is concurrently output through the main output device and the first auxiliary device when the connecting part detects that the first auxiliary output device is connected to the connecting part.

The controller controls the output of the audio signal so that the audio signal is output only through the second auxiliary output device when the connecting part detects that the second auxiliary output device is connected to the connecting part.

The first auxiliary output device may include a 4 band- (3 ring-) typed connector connected to the connecting part.

The first output device may include a connection detecting signal generator outputting a connection detecting signal through the connector when the connector of the first auxiliary output device is connected to the connecting part.

The connection detecting signal generator may include a pull-down resistor outputting a pull-down signal through the connector when the connector of the first auxiliary output device is connected to the connecting part.

The connecting part may include a pull-up/pull-down circuit to output a pull-up signal or a pull-down signal when one of the auxiliary output devices is connected to the connecting part, and a connecting detector including a logic element performing a logic operation based on a combination of the pull-up signal and the pull-down signal which are outputted from the pull-up/pull-down circuit and outputting as result of the logic operation to the controller.

The pull-up/pull-down circuit may include a first output part outputting the pull-down signal when the first auxiliary output device is connected to the connecting part and outputting the pull-up signal when the first auxiliary output device is not connected thereto, and a second output part outputting the pull-up signal when the first auxiliary output device or the second auxiliary output device is connected to the connecting part.

The pull-up/pull-down circuit may output the pull-down signal from the pull-down resistor of the connection detecting signal generator to the first output part when the first auxiliary output device is connected to the connecting part.

The auxiliary output devices may include a power supply connector to receive power from the computer main body.

According to another aspect of the present invention, there is provided a control method of a computer apparatus including a computer main body, and a main output device in the computer main body outputting an audio signal, including: providing a connecting part to which a first auxiliary output device and a second auxiliary output device are selectively connectable; and detecting whether either the first auxiliary output device or the second auxiliary output device is connected to the connecting part. The detecting includes concurrently outputting the audio signal to the main output device and to the first auxiliary output device when the first auxiliary output device is detected to be connected.

The detecting may also include outputting the audio signal only to the second auxiliary output device when the second auxiliary output device is detected to be connected thereto.

According to another aspect of the present invention, there is provided a computer control method, including: determining whether a subwoofer is connected to a computer and outputting an audio signal to the subwoofer and a main speaker when a subwoofer is determined to be connected; and determining whether a pair of headphones is connected to the computer and outputting an audio signal only to the headphones when a pair of headphones is determined to be connected.

According to another aspect of the present invention, there is provided a computer including: an audio signal input part to receive an audio signal; an audio compressor/decompressor (codec) to process the input audio signal; an audio amplifier to amplify the processed input audio signal; a main speaker to output the processed audio signal; a connection part to which auxiliary output devices are connectable; a connecting detector to detect a type of auxiliary output device connected to the connection part; and a controller to control an output path of the output audio signal based on the detected type of connected auxiliary output device, the audio signal being outputted through the main speaker and a first auxiliary output device when the connecting part detects that the first auxiliary part is connected to the connecting part and being outputted only through a second auxiliary output device when the connecting part detects that the second auxiliary connection device is connected to the connecting part.

Additional and/or other aspects and advantages of the present invention will be set forth in part in the description which follows and, in part, will be obvious from the description, or may be learned by practice of the invention.

### BRIEF DESCRIPTION OF THE DRAWINGS

These and/or other aspects and advantages of the present invention will become apparent and more readily appreciated from the following detailed description, taken in conjunction with the accompanying drawings of which:

FIG. 1 is an audio amplifier and a peripheral circuit of a conventional computer apparatus;

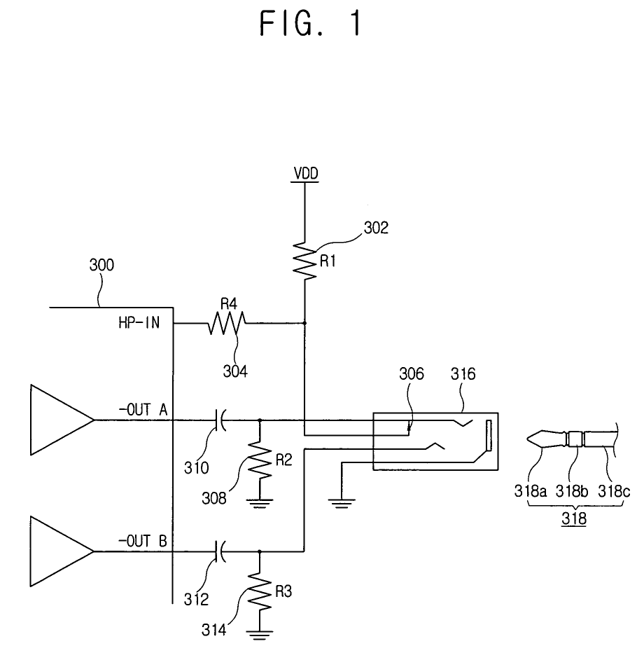

FIG. 2 is a control block diagram of a computer apparatus according to an embodiment of the present invention;

FIG. 3 illustrates a subwoofer connectable to the computer apparatus of FIG. 2;

FIG. 4 is a partially detailed circuit diagram of when the subwoofer of FIG. 3 is connected to an audio jack of FIG. 2; and

FIG. 5 is a flowchart of a control method of computer apparatus according to an embodiment of the present invention.

### DETAILED DESCRIPTION OF EMBODIMENT

Reference will now be made in detail to an embodiment of the present invention, examples of which are illustrated in the accompanying drawings, wherein like reference numerals refer to the like elements throughout. The embodiment is described below in order to explain the present invention by referring to the figures.

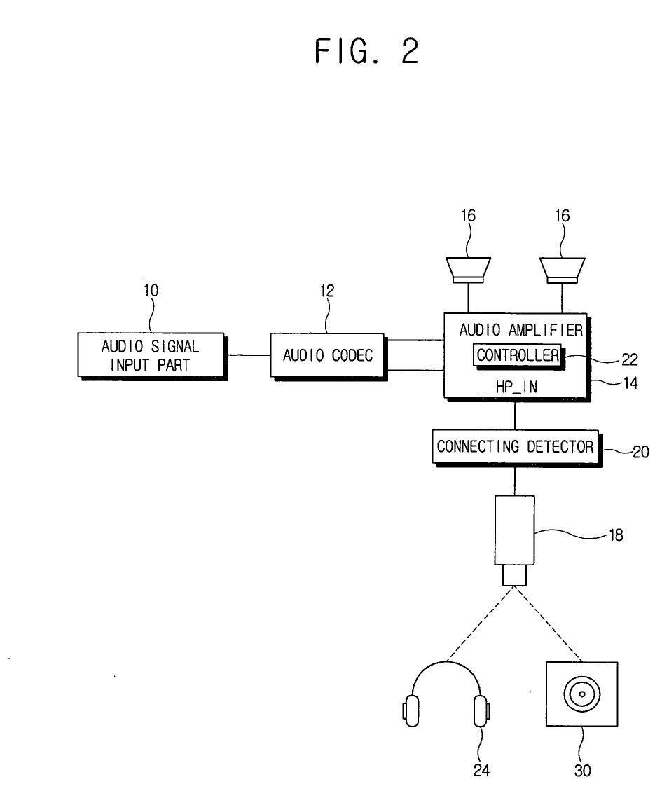

As shown in FIG. 2, a computer apparatus according to an embodiment of the present invention includes: an audio signal input part 10 to receive an audio signal; an audio codec 12 and an audio amplifier 14 to process the audio signal inputted through the audio signal input part 10; a main speaker section 16 to output the audio signal processed by the audio codec 12 and the audio amplifier 14; an audio jack 18 to which a pair of headphones 24 and a subwoofer 30 are selectively connectable; a connecting detector 20 to detect whether either the headphones 24 or the subwoofer 30 is connected to the audio jack 18; and a controller 22 to control an outputting direction of the audio signal based on a detecting result of the connecting detector 20. Herein, the main speaker section 16 may be used as a main output device, and the headphone 24 and the subwoofer 30 may be used as auxiliary output devices. The audio jack 18 and the connecting detector 20 may be used as a connecting part to which the auxiliary output devices are selectively connected, and to detect connecting or disconnecting of the auxiliary output devices thereto.

The audio signal input part 10 may include a connecting terminal to which an external audio apparatus is connected, or an OS transmitting a digital audio data to the audio codec 12 through a driver.

The audio codec 12 receives the digital audio data from the audio signal input part 10, decodes the digital audio data into an analog audio signal, and then transmits the analog audio signal to the audio amplifier 14.

The audio amplifier 14 outputs the analog audio signal after amplifying the analog audio signal from the audio codec 12, and includes an HP-IN pin. When a low signal is inputted to the HP-IN pin, the audio amplifier 14 is operated in a speaker mode. When a high signal is inputted to the HP-IN pin, the audio amplifier 14 is operated in a headphone mode.

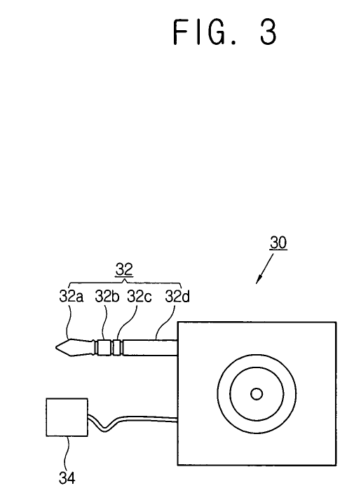

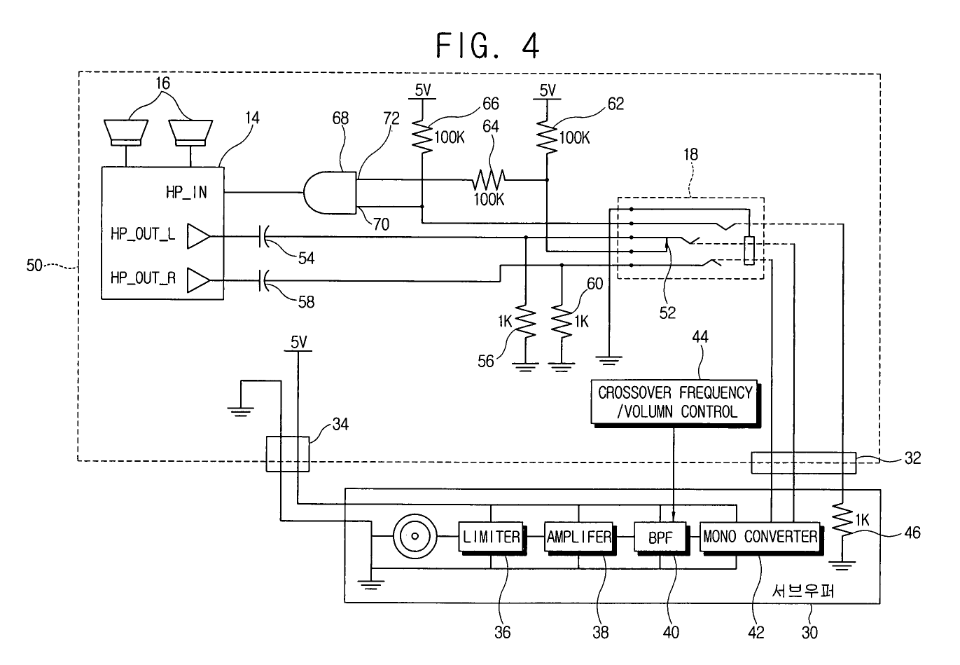

As shown in FIG. 3, the subwoofer 30 includes a 4 band- (3 ring-) type plug 32 which is connectable to the audio jack 18, and a USB connector 34 to supply power from a computer 50 (shown in FIG. 4). The subwoofer 30 includes the 4 band- typed plug 32 so as to respectively receive right, left, and woofer audio signals from an Audio R signal portion 32b, an Audio L signal portion 32a, a woofer-in signal portion 32c, and a Ground signal portion 32d. While a USB connector is shown and described as supplying the power, it is to be understood that other types of connectors may be used. The subwoofer 30 uses the power of the computer 50 through the USB connector 34 so that the subwoofer 30 does not need a separate power adaptor.

Referring to FIGS. 2 and 3, controller 22 provided in the audio amplifier 14, outputs the audio signal through the headphone 24 when the connecting detector 20 detects that the headphone 24 is connected to the audio jack 18 like a conventional controller. Then, the controller 22 cuts off output of the audio signal to the main speaker section 16 (a so-called headphone mode).

The controller 22 outputs the audio signal through the subwoofer 30 and the main speaker section 16 when the connecting detector 20 detects that the subwoofer 30 is connected to the audio jack 18 (a so-called speaker mode).

The audio jack 18, the subwoofer 30, and the connecting detector 20 will be described in detail by referring to FIG. 4.

As shown in FIG. 4, a plug 32 of the subwoofer 30 is connected to the audio jack 18, and the USB connector 34 of the subwoofer 30 is connected to an USB port (not shown). The subwoofer 30 is supplied with the power from the computer 50 through the USB connector 34, and outputs the audio signal inputted through the audio jack 18 after processing the audio signal.

The audio jack 18 to which the plug 32 of the subwoofer 30 is connected, is a 3 position-typed jack, and includes a control pin 52 to be opened/closed according to the condition of connecting of the plug 32.

The subwoofer 30 includes a mono converter 42 converting a stereo audio signal into a mono audio signal; a Band Pass Filter (BPF) 40 modulating a frequency bandwidth of the audio signal inputted from the computer 50; an amplifier 38 amplifying the audio signal; and a limiter 36 to limit excessive increasing of a level of the audio signal with respect to frequency below predetermined band. A gain of the BPF 40 and cut-off frequency of the BPF 40 are modulated according to a crossover frequency/volume control 44 provided in the computer 50.

The subwoofer 30 includes a pull-down resistor 46 to output a low signal when the subwoofer 30 is connected to the audio jack 18. Specifically, the low signal is outputted from a grounded circuit including the pull-down resistor 46. Accordingly, the pull-down resistor 46 outputs a connection detecting signal so that the connecting detector 20 may detect connection or disconnection of the subwoofer 30.

The connecting detector 20 comprises an AND gate 68 connected to the HP-IN pin of the audio amplifier 14, and a plurality of resistors 62, 64, and 66 respectively connected to first and second input parts 70 and 72 of the AND gate 68 and constituting a pull-up/pull-down circuit.

When the 4 band- (3 ring-) typed plug 32 of the subwoofer 30 is connected to the audio jack 18, the low signal is inputted to a first input part 70 of the AND gate 68 by the pull-down resistor 46 in the subwoofer 30. The high signal is inputted to a second input part 72 of the AND gate 68, because when the plug 32 of the subwoofer 30 is connected to the audio jack 18, the control pin 52 of the audio jack 18 is opened and the second input part 72 of the AND gate 68 is in a pull-up state.

Accordingly, the high signal and the low signal inputted into the respective first and second input parts 70 and 72 of the AND gate 68 are calculated by logic AND, and the low signal is outputted into an output part of the AND gate 68 and the low signal which is an output of the AND gate 68, is transmitted to the HP-IN pin. Accordingly, the HP-IN pin is in a low state, and the controller 22 performs the speaker mode so that the controller 22 maintains the output of the main speaker section 16 and at the same time outputs the audio signal to the subwoofer 30. Herein, the audio signal of a mid- to high-frequency is outputted through the main speaker section 16 and the audio signal of a low- to mid-frequency is outputted through the subwoofer 30.

When a 3 band- (2 ring-) typed plug (not shown) which is widely used in a headphone is connected to the audio jack 18, the 3 band-typed plug is not connected to a part of the audio jack 18 to which the pull-down resistor 46 of the subwoofer 30 is connected, so that the first input part 70 of the AND gate 68 is always in the pull-up state.

When the 3 band formed plug is connected to the audio jack 18, the control pin 52 in the audio jack 18 is opened. Accordingly, the second input part 72 of the AND gate 68 becomes in the pull-up state and the high signal is outputted to the output part of the AND gate 68.

Accordingly, the high signal is inputted into the HP-IN pin of the audio amplifier 14, and the controller 22 performs the headphone mode so that the controller 22 controls the audio signal outputted only to the headphone 24.

Reference numerals 54 and 58 are capacitors, and reference numerals 56 and 60 are resistors. A circuit comprising the capacitors 54 and 58 and the resistors 56 and 60 is employed for a filter.

As described above, according to connecting or disconnecting of the subwoofer 30 and the headphone 24, the first input part 70 of the AND gate 68 receives the pull-up signal or the pull-down signal outputted from a first output part of a pull-up/pull-down circuit. The second input part 72 receives the pull-up signal outputted from a second output part of the pull-up/pull-down circuit. However it is understood that other configurations can be possible.

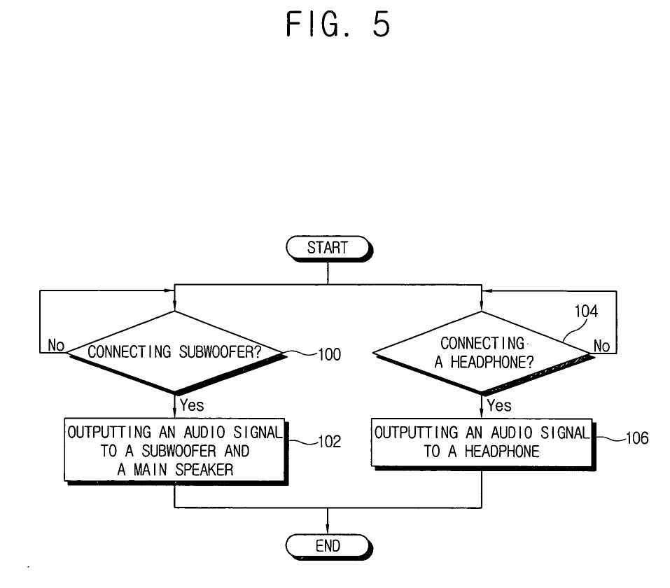

A controlling flow of the computer apparatus according to an embodiment of the present invention will be described by referring to FIG. 5 as follows.

When at the connecting detector 20 it is detected that the subwoofer 30 is connected thereto at operation 100, the controller 22 controls the audio signal to be outputted through the subwoofer 30 and the main speaker section 16 at operation 102. When the connecting detector 20 detects that headphones 24 are connected thereto at operation 104, the controller 22 controls the audio signal to be outputted through the headphone 24 at operation 106.

As describe above, the auxiliary speaker includes the subwoofer 30. However, the auxiliary speaker may include an external speaker and it is to be understood that other mechanism can be used.

As described above, the connecting detector 20 includes the plurality of resistors 62, 64, and 66 and the AND gate 68. However, it is to be understood that other configurations can be used.

According to the above-described embodiment of the present invention, when the auxiliary speaker is connected to the audio jack to which the auxiliary speaker and the headphone are selectively connected, the audio signal is outputted through the auxiliary speaker and the main speaker. When the headphone is connected to the audio jack, the audio signal is outputted through the headphone. Accordingly, the above-described embodiment of the present invention improves sound of the low- to mid frequency by maintaining output of the main speaker when the auxiliary speaker is connected thereto.

Although an embodiment of the present invention have been shown and described, the present invention is not limited to the described embodiment. Instead, it would be appreciated by those skilled in the art that changes may be made to the embodiment without departing from the principles and spirit of the invention, the scope of which is defined by the claims and their equivalents.

What is claimed is:

1. A computer apparatus comprising:
a computer main body including a main output device outputting an audio signal, a controller, and a connecting part;
a first auxiliary output device to output an audio signal; and
a second auxiliary output device to output the audio signal,
wherein the first auxiliary output device and the second auxiliary output device are selectively connectable to the connecting part,
wherein the connecting part detects whether either the first auxiliary output device or the second auxiliary output device is connected thereto, and
wherein the controller controls the output of the audio signal so that the audio signal is concurrently output through the main output device and the first auxiliary device when the connecting part detects that the first auxiliary output device is connected to the connecting part.

2. The computer apparatus according to claim 1, wherein the controller controls the output of the audio signal so that the audio signal is output only through the second auxiliary output device when the connecting part detects that the second auxiliary output device is connected to the connecting part.

3. The computer apparatus according to claim 1, wherein the first auxiliary output device includes a 4 band- (3 ring-) typed connector connected to the connecting part.

4. The computer apparatus according to claim 3, wherein the first auxiliary output device includes a connection detecting signal generator outputting a connection detecting signal through the connector when the connector of the first auxiliary output device is connected to the connecting part.

5. The computer apparatus according to claim 4, wherein the connection detecting signal generator includes a pull-down resistor output a pull-down signal through the connector when the connector of the first auxiliary output device is connected to the connecting part.

6. The computer apparatus according to claim 5, wherein the connecting part includes a pull-up/pull-down circuit to output a pull-up signal or a pull-down signal when one of the auxiliary output devices is connected to the connecting part, and a connecting detector including a logic element performing a logic operation based on a combination of the pull-up signal and the pull-down signal which are outputted from the pull-up/pull-down circuit and outputting a result of the logic operation to the controller.

7. The computer apparatus according to claim 6, wherein the pull-up/pull-down circuit includes a first output part outputting the pull-down signal when the first auxiliary output device is connected to the connecting part and outputting the pull-up signal when the first auxiliary output device is not connected thereto, and a second output part outputting the pull-up signal when the first auxiliary output device or the second auxiliary output device is connected to the connecting part.

8. The computer apparatus according to claim 7, wherein the pull-up/pull-down circuit outputs the pull-down signal from the pull-down resistor of the connection detecting signal generator to the first output part when the first auxiliary output device is connected to the connecting part.

9. The computer apparatus according to claim 1, wherein both the first and second auxiliary output devices include a power supply connector which receives power from the computer main body.

10. A control method of a computer apparatus including a computer main body, and a main output device in the computer main body outputting an audio signal, comprising:
providing a connecting part to which a first auxiliary output device and a second auxiliary output device are selectively connectable; and
detecting whether either the first auxiliary output device or the second auxiliary output device is connected to the connecting part,
wherein the detecting includes concurrently outputting the audio signal to the main output device and to the first auxiliary output device when the first auxiliary output device is detected to be connected.

11. The control method of the computer apparatus according to claim 10, wherein the detecting includes outputting the audio signal only to the second auxiliary output device when the second auxiliary output device is detected to be connected.

12. A computer control method, comprising:
determining whether a subwoofer is connected to a computer and outputting an audio signal to the subwoofer and a main speaker when a subwoofer is determined to be connected; and
determining whether a pair of headphones is connected to the computer and outputting an audio signal only to the headphones when a pair of headphones is determined to be connected.

13. A computer comprising:
an audio signal input part to receive an audio signal;
an audio compressor/decompressor (codec) to process the input audio signal;
an audio amplifier to amplify the processed input audio signal;
a main speaker to output the processed audio signal;
a connection part to which auxiliary output devices are connectable;
a connecting detector to detect a type of auxiliary output device connected to the connection part; and
a controller to control an output path of the output audio signal based on the detected type of connected auxiliary output device, the audio signal being output through only the main speaker and a first auxiliary output device when the connecting part detects that the first auxiliary part is connected to the connecting part and being output only through a second auxiliary output device when the connecting part detects that the second auxiliary connection device is connected to the connecting part.

14. The computer of claim 13, wherein the first auxiliary output device is a subwoofer and the second auxiliary output device is a pair headphones.
